(19) United States
(12) Patent Application Publication
(10) Pub. No.: US 2026/0259774 A1
(43) Pub. Date: Sep. 3, 2026

(54) RECORDING MEDIUM STORING PROGRAM FOR INFORMATION PROCESSING

(71) Applicant: PFU Limited, ISHIKAWA (JP)

(72) Inventor: Akira IWAYAMA, ISHIKAWA (JP)

(21) Appl. No.: 19/552,257

(22) Filed: Feb. 27, 2026

(30) Foreign Application Priority Data
Mar. 3, 2025 (JP) 2025-033113

(51) Int. Cl. G06F 9/50

(52) U.S. Cl. CPC G06F 9/5027

(57) ABSTRACT

A non-transitory recording medium storing a plurality of instructions which, when executed by one or more processors on a first information processing device, causes the one or more processors to perform an information processing method including: receiving a request for executing a task from a second information processing device; setting a third information processing device to execute the task; and generating reward information related to execution of the task based on information indicating computing resources for the task.

### CROSS-REFERENCE TO RELATED APPLICATIONS

This patent application is based on and claims priority pursuant to 35 U.S.C. §119(a) to Japanese Patent Application No. 2025-33113, filed on March 3, 2025, in the Japan Patent Office, the entire disclosure of which is hereby incorporated by reference herein.

### BACKGROUND

The present disclosure relates to a non-transitory recording medium storing a program for information processing.

A job management system that executes a task requested via a network has been proposed. For example, in response to a request for a job transmitted from one user terminal, the job is executed by using computer resources in another user terminal, and a reward for the execution of the job is paid. The job management system includes a plurality of node devices that distribute and store notifications, which are transmitted from one user terminal to one or more other terminals, in executing the series of processes for the job.

### SUMMARY

A non-transitory recording medium according to one aspect of the present disclosure stores a plurality of instructions which, when executed by one or more processors on a first information processing device, causes the one or more processors to perform an information processing method including: receiving a request for executing a task from a second information processing device; setting a third information processing device to execute the task; and generating reward information related to execution of the task based on information indicating computing resources for the task.

A non-transitory recording medium according to another aspect of the present disclosure stores a plurality of instructions which, when executed by one or more processors on a second information processing device, causes the one or more processors to perform an information processing method including: transmitting a request for executing a task to a third information processing device; and transmitting information indicating computing resources for the task to one of a first information processing device and the third information processing device.

A non-transitory recording medium according to still another aspect of the present disclosure stores a plurality of instructions which, when executed by one or more processors on a third information processing device, causes the one or more processors to perform an information processing method including: executing a task in response to a request for executing the task; and transmitting information indicating computing resources for the task to one of a first information processing device and a second information processing device.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of a general arrangement of a task management system;

FIG. 2 is a block diagram illustrating an example of a hardware configuration of a computer;

FIG. 3 is a block diagram illustrating an example of a functional configuration of a server device;

FIG. 4 is a table of an example of evaluation information;

FIG. 5 is a diagram illustrating an example of access limitation;

FIG. 6 is a diagram illustrating an example of an evaluation input screen;

FIG. 7 is a block diagram illustrating an example of a functional configuration of an edge device;

FIG. 8 is a sequence diagram illustrating an example of a registration process; and

FIG. 9 is a sequence diagram illustrating an example of an execution process.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms "a," "an," and "the" are intended to include the plural forms as well, unless the context clearly indicates otherwise.

According to an embodiment of the present disclosure, an example of a task management system that manages a task is described. In the task management system, a plurality of information processing apparatuses share the computing resources to execute a task. Specifically, when an information processing apparatus does not have the computing resources necessary for executing a task, the information processing apparatus requests another information processing apparatus to execute the task, such that the computing resources are shared between the information processing apparatuses when executing the task.

For example, when real-time processing is performed in edge computing, there may be a free space available in the computing resources of an edge device. The edge device may include a computing device specialized in artificial intelligence (AI) processing, such as a neural network processing unit (NPU). However, when a server device having a large amount of computing resources is performing processing, the computing device of the edge device is not used, and thus the computing resources of the entire system are not effectively used. Further, the server device requires a large amount of electric power, resulting in inefficient use of electric power. When a plurality of edge devices are used, it is desired to securely manage data to be processed.

By allocating the computing resources that are available in the edge device to the task to be executed by another edge device, the computing resources that are available in the edge device can be effectively used. With the increased number of edge devices providing the available computing resources, the computing resources can be more effectively utilized.

To encourage the edge devices to provide the computing resources, the rewards may be paid for providing the computing resources. It is thus desired to acquire reward information, which is to be used to appropriately calculate the reward for providing the computing resources. An example of a task management system that can generate reward information related to the execution of the task will be described below.

### General Arrangement

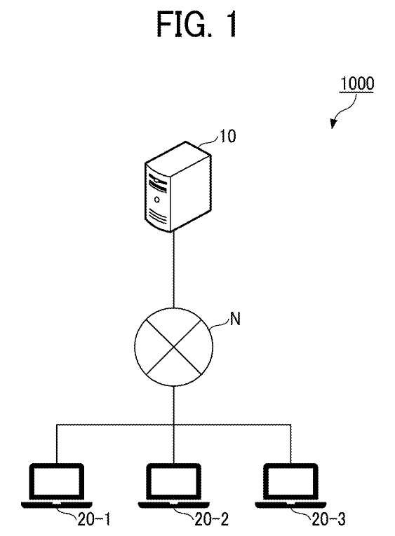

FIG. 1 is a diagram illustrating an example of a general arrangement of a task management system 1000 according to a first embodiment. As illustrated in FIG. 1, the task management system 1000 includes a server device 10 and two or more edge devices 20-1 to 20-3. The edge devices 20-1 to 20-3 may be collectively referred to as the edge device 20. The server device 10 and the edge device 20 are communicably connected to each other via a communication network N. The communication network N may be a communication network such as a local area network (LAN), a virtual private network (VPN), or the Internet. The communication between the server device 10 and the edge device 20 may be encrypted communication. The encrypted communication is, for example, communication based on Hypertext Transfer Protocol Secure (HTTPS).

In the following description, when the edge devices 20-1 to 20-3 need to be distinguished from one another, reference signs with suffixes are used for distinction, such as edge device "20-1" and edge device "20-2". When the edge devices 20-1 to 20-3 are collectively referred to, the edge device "20" is used.

The server device 10 is an example of an information processing device that uses the shared computing service. The shared computing service is an example of an information communication service that executes a predetermined task while sharing the computing resources between the edge devices 20. The server device 10 may be, for example, a personal computer, a workstation, or a server.

The edge device 20 is another example of an information processing device that uses the shared computing service. The edge device 20 may be, for example, a personal computer, a tablet terminal, or a smartphone.

The two or more edge devices 20 include an edge device that receives the computing resources, which may be referred to as the "resource receiving device”, and an edge device that provides the computing resources, which may be referred to as the "resource providing device". In the present embodiment, the term “receiving the computing resources” means to cause another edge device to execute the task. Further, the term “providing the computing resources” means to execute the task for another edge device. One edge device 20 may function as the resource receiving device or the resource providing device depending on the situation. The edge devices 20 may further include the edge device 20 that functions only as the resource receiving device, or the edge device 20 that functions only as the resource providing device.

The general arrangement of the task management system 1000 illustrated in FIG. 1 is one example, and the system configuration of the task management system 1000 may vary depending on the application or purpose. For example, the task management system 1000 may include two or more server devices 10. In another example, the task management system 1000 may include three or more edge devices 20. In another example, the server device 10 may be implemented by multiple computers or may be implemented as a cloud computing service. The classification of apparatuses such as the server device 10 and the edge device 20 illustrated in FIG. 1 is an example.

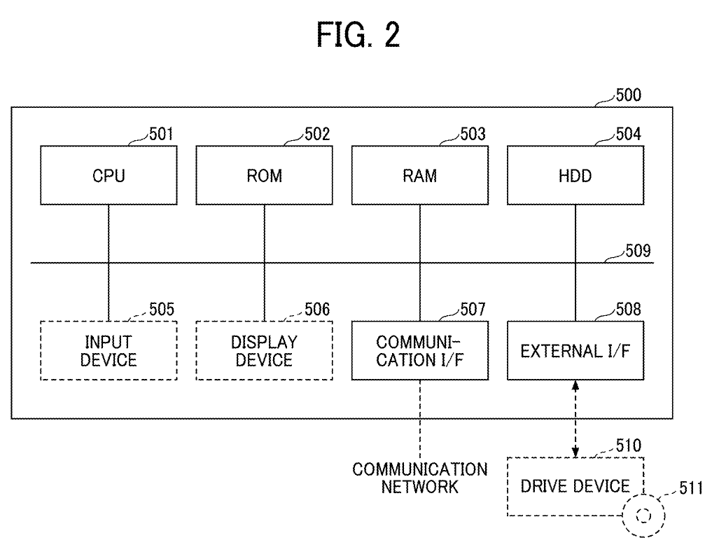

Hardware Configuration A hardware configuration of the task management system 1000 will be described with reference to FIG. 2. The server device 10 and the edge device 20 may each be implemented by, for example, a computer. FIG. 2 is a block diagram illustrating an example of a hardware configuration of a computer 500.

As illustrated in FIG. 2, the computer 500 includes a central processing unit (CPU) 501, a read-only memory (ROM) 502, a random-access memory (RAM) 503, a hard disk drive (HDD) 504, an input device 505, a display device 506, a communication interface (I/F) 507, and an external I/F 508. The CPU 501, the ROM 502, and the RAM 503 form a so-called computer. The hardware components of the computer 500 are connected to one another via a bus line 509. The input device 505 and the display device 506 may be connected to the computer 500 via the external I/F 508 for use.

The CPU 501 reads programs or data from a storage device such as the ROM 502 or the HDD 504 into the RAM 503 and executes processes based on the programs or data to control the overall operation of the computer 500 or implement the functions of the computer 500. The computer 500 may include a graphics processing unit (GPU) or a neural network processing unit (NPU) in addition to the CPU 501 or instead of the CPU 501.

The ROM 502 is an example of a nonvolatile semiconductor memory (storage device) that retains the programs or data even after the power is turned off. The ROM 502 functions as a main storage device that stores various programs or data used by the CPU 501 to execute the various programs installed on the HDD 504. Specifically, the ROM 502 stores boot programs such as a basic input/output system (BIOS) and an extensible firmware interface (EFI), which are executed at the time of booting the computer 500, and data such as operating system (OS) settings and network settings.

The RAM 503 is an example of a volatile semiconductor memory (storage device) from which programs or data are erased when the power is turned off. The RAM 503 is, for example, a dynamic random-access memory (DRAM) or a static random-access memory (SRAM). The RAM 503 provides a work area to which the various programs installed on the HDD 504 are loaded when the programs are executed by the CPU 501.

The HDD 504 is an example of a nonvolatile memory (storage device) that stores programs or data. The programs or data stored in the HDD 504 include an OS that is basic software for controlling the computer 500 and applications that provide various functions on the OS. The computer 500 may use a storage device using a flash memory as a storage medium, such as a solid-state drive (SSD), instead of the HDD 504.

The input device 505 is used by a user to input various signals. Examples of the input device 505 include a touch panel, operation keys or buttons, a keyboard, a mouse, and a microphone for inputting sound data such as voice.

The display device 506 includes at least a display such as a liquid crystal display or an organic electro-luminescence (EL) display that displays a screen, and a speaker that outputs sound data such as voice.

The communication I/F 507 is an interface for connecting the computer 500 to a communication network to allow the computer 500 to perform data communication.

The external I/F 508 is an interface between the computer 500 and an external device. Examples of the external device include a drive device 510.

The drive device 510 is a device to which a recording medium 511 is placed. Examples of the recording medium 511 include media that optically, electrically, or magnetically record information, such as a compact disc read-only memory (CD-ROM), a flexible disk, and a magneto-optical disk. Other examples of the recording medium 511 include a semiconductor memory that electrically records data such as a ROM or a flash memory. The external I/F 508 allows the computer 500 to read or write data from or to the recording medium 511.

For example, the distributed recording medium 511 may be inserted into the drive device 510 connected to the external I/F 508, and the drive device 510 reads the various programs recorded on the recording medium 511, so that the various programs are installed on the HDD 504. Alternatively, the various programs may be downloaded from another network different from the communication network via the communication I/F 507, so that the various programs are installed on the HDD 504.

### Functional Configuration

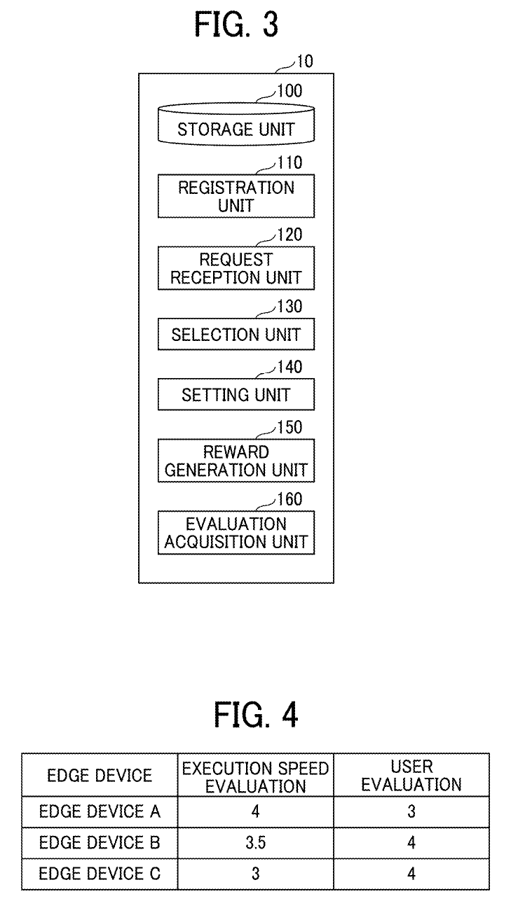

A functional configuration of the task management system 1000 will be described below with reference to FIGS. 3 to 7.

FIG. 3 is a block diagram illustrating an example of a functional configuration of the server device 10. As illustrated in FIG. 3, the server device 10 includes a storage unit 100, a registration unit 110, a request reception unit 120, a selection unit 130, a setting unit 140, a reward generation unit 150, and an evaluation acquisition unit 160. The server device 10 executes one or more programs that are pre-installed to function as the storage unit 100, the registration unit 110, the request reception unit 120, the selection unit 130, the setting unit 140, the reward generation unit 150, and the evaluation acquisition unit 160.

For example, the storage unit 100 is implemented by the HDD 504 illustrated in FIG. 2. For example, the registration unit 110, the request reception unit 120, the selection unit 130, the setting unit 140, the reward generation unit 150, and the evaluation acquisition unit 160 are implemented by processing that is executed by the CPU 501 according to the program that is loaded from the HDD 504 illustrated in FIG. 2 into the RAM 503.

The storage unit 100 stores account information. The account information is information related to an account of the shared computing service. In the present embodiment, the account information includes identification information, user information, connection destination information, task information, payment information, encryption information, and evaluation information, each related to the account.

The identification information of the account is any information for identifying the account. The identification information of the account is so-called identification (ID) information, and may be a character string including alphanumeric characters and symbols that can be freely set, or an email address used for registering the account.

The user information is information on the user who uses the edge device 20. Examples of the user information include an account name, a password, a name, an address, an email address, and other attribute information regarding the user.

The connection destination information is information used for connecting to the edge device 20. Examples of the connection destination information include a media access control (MAC) address, an Internet protocol (IP) address, a uniform resource locator (URL), and a password.

The task information is information about a task that can be executed by the edge device 20. The task may be, for example, a task to be executed based on the machine learning model. Examples of the machine learning model include a prediction model, a classification model, a recognition model, a generative model, a language model, and a base model.

The task information may include information on the computing resources that can be provided by the edge device 20. The computing resources may include the number, type, performance, or version of the NPU or the GPU in the edge device 20, or the capacity, type, or bandwidth of the memory in the edge device 20.

The payment information is information used for paying the reward to the operating entity operating the edge device 20. Examples of the operating entity include a user, an owner, and an administrator of the edge device 20. Further, the operating entity may be a natural person or a corporation. Examples of the payment information of the operating entity include account information of a financial institution such as a bank or a securities company, account information of electronic money, and account information of a point service.

The encryption information is information used to encrypt data communication with the edge device 20. Examples of the encryption information include a public key of a public key encryption scheme, an electronic signature, and an electronic certificate. For example, when data communication is encrypted by the public key encryption scheme, the edge device 20 operating as the transmission source encrypts data using the public key of the edge device 20 operating as the transmission destination. The edge device 20 operating as the transmission destination decrypts the encrypted data using a private key of the edge device 20 operating as the transmission destination. When the edge device 20 does not encrypt data communication, the encryption information may not be stored.

The evaluation information is information related to the evaluation of the edge device 20. In the present embodiment, the evaluation information includes an evaluation result of a task executed by the edge device 20 that is the resource providing device. For example, the evaluation result includes information on the execution speed of the task. Alternatively or additionally, the evaluation result includes an evaluation value input to the edge device 20 that is the resource receiving device.

FIG. 4 is a table of an example of the evaluation information. As illustrated in FIG. 4, the evaluation information includes, as data items, an edge device, an execution speed evaluation, and a user evaluation. The edge device is information indicating the edge device 20 to be evaluated. The execution speed evaluation is an example of information related to the execution speed of the task. The execution speed evaluation illustrated in FIG. 4 is an evaluation value obtained by converting the execution speed of the task into a numerical value ranging from 1 to 5. The user evaluation is an example of an evaluation value input to the edge device 20. The user evaluation illustrated in FIG. 4 is an evaluation value input by the user of the resource receiving device, which is rated in five levels.

The registration unit 110 registers the account information. In one example, the registration unit 110 registers the account information based on information input to the server device 10. Alternatively, the registration unit 110 registers the account information in response to a registration request from the edge device 20. When the registration of the account information is completed, the registration unit 110 transmits a registration completion notification of the account, which indicates that registration of the account is completed, to the edge device 20. The registration completion notification of the account includes the identification information of the account.

The registration request may include constraint information indicating the requirement for allowing the execution of the task. For example, the constraint information included in the registration request includes the requirement of the resource receiving device that is allowed by the resource providing device to receive the execution request of the task from the resource providing device. In other words, the constraint information included in the registration request is information indicating a limitation on the access from the resource receiving device to the resource providing device, and is set by the resource providing device.

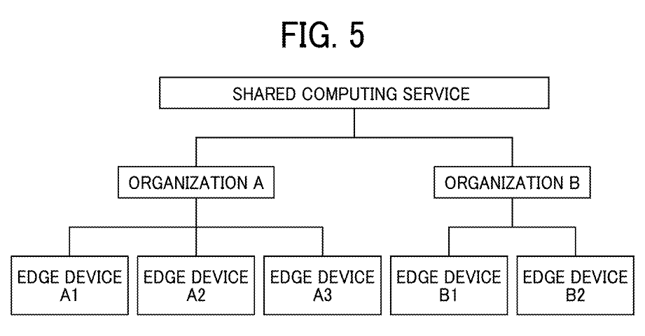

FIG. 5 is a diagram illustrating an example of the access limitation. As illustrated in FIG. 5, organizations such as organization A and organization B may use the shared computing service. Examples of the organization include, but are not limited to, a company, a department in a company, and a group of companies. Each organization may operate one or more edge devices. In the example illustrated in FIG. 5, the organization A operates three edge devices A1, A2, and A3, and the organization B operates two edge devices B1 and B2. There may be a case where the organization A is desired to make the edge devices accessible from one another only if those edge devices are within the same organization. For example, when the edge device A1 is the resource receiving device, the edge device A2 or the edge device A3 can be the resource providing device, such that none of the edge device B1 and the edge device B2 can be the resource providing device. The access limitation illustrated in FIG. 5 can be implemented using the constraint information that requires the resource providing device to be the edge device within the organization to which the edge device as the resource receiving device belongs.

The request reception unit 120 receives a request for executing a task, which may be referred to as a task execution request. The request reception unit 120 receives the task execution request from the resource receiving device. The task execution request includes information indicating the task to be executed. For example, the task execution request includes information indicating the computing resources required for executing the task.

The task execution request may further include constraint information indicating the requirement for allowing the execution of the task. For example, the constraint information included in the task execution request includes the requirement of the resource providing device that is allowed by the resource receiving device to transmit the task execution request. In other words, the constraint information included in the task execution request is information indicating a limitation on the access from the resource providing device to the resource receiving device, and is set by the resource receiving device.

The selection unit 130 selects the edge device 20 that executes the task, which is the resource providing device. The selection unit 130 may select the resource providing device from the edge devices 20 that can execute the task indicated in the task execution request.

Alternatively, the selection unit 130 selects the resource providing device based on the resource availability information. The resource availability information indicates the computing resources that can be provided by the edge device 20 executing the task. Examples of the resource availability information include the available capacity of a memory, the size of data that can be processed, and the unused rate of a processor such as a CPU, GPU, or NPU. The selection unit 130 may collect the resource availability information from each edge device 20 that can execute the task, and select the edge device 20 having the largest amount of computing resources available for use by the resource providing device.

In another example, the selection unit 130 selects the resource providing device based on the evaluation information. The selection unit 130 may read the evaluation information of the edge device 20 that can execute the task from the storage unit 100, and select the edge device 20 having the highest evaluation as the resource providing device. The level of the evaluation may be compared between the edge devices 20 using one evaluation index or a statistical value of two or more evaluation indices. For example, the selection unit 130 selects the edge device 20 having the highest execution speed. In another example, the selection unit 130 selects the edge device 20 having the largest sum of the evaluation value for the execution speed and the evaluation value input by the user.

Further, the selection unit 130 may select two or more edge devices 20 each as a candidate for the resource providing device. The selection unit 130 transmits the candidates for the resource providing device to the resource receiving device that has transmitted the task execution request, for example, via the server device 10. The resource receiving device selects the resource providing device from the candidates for the resource providing device, which is received from the server device 10.

The setting unit 140 sets the edge device 20 that executes the task, which is the resource providing device. In one example, the setting unit 140 sets the edge device 20 selected by the selection unit 130 as the resource providing device. In another example, the setting unit 140 sets the edge device 20 selected by the resource receiving device from the candidates for the resource providing device as the resource providing device.

The setting unit 140 transmits the connection destination information of the edge device 20, which is set as the resource providing device, to the resource receiving device. The setting unit 140 may transmit the encryption information of the resource providing device to the resource receiving device together with the connection destination information of the resource providing device. The setting unit 140 may further divide the task into two or more tasks, and transmit the divided tasks to the edge devices 20.

The reward generation unit 150 generates reward information related to the execution of the task. The reward information is information related to the reward to be paid to the operating entity of the edge device 20. The reward may be paid from the operating entity of the task management system 1000 or may be paid from the operating entity of another edge device 20. The reward may be paid in currency, or may be paid in a manner convertible into points, coupons, electronic money, or virtual currency.

The reward generation unit 150 generates the reward information based on the resource use information. The resource use information is information indicating the computing resources related to the task. The information indicating the computing resources may include one or both of information related to the processing content of the task and information related to the data to be processed by the task.

The information related to the processing content includes at least one of the number of parameters of the machine learning model that executes the task, the processing capacity of the computing device in the resource providing device, the size of the program that executes the task, the size of the memory required for executing the task, and the number of times the task is executed.

The information related to the data to be processed includes at least one of the number of data, the size of the data, the number of tokens of the data, the occupancy rate of the computing device or the memory for the task being executed, the processing time of the task being executed, and the number of times the computing is performed when the task is executed.

For example, the reward generation unit 150 generates the reward information based on the product of the number of tokens and the number of parameters. The number of parameters is the number of parameters of the machine learning model that executes the task. The number of parameters may be previously registered in the task information. The number of parameters is the number of variables required to optimize the machine learning model. The number of parameters is uniquely determined according to the optimized machine learning model. The number of tokens is the number of tokens included in the data to be processed by the task. The token is a processing unit obtained by dividing text data into units of words.

For example, the reward generation unit 150 may generate the reward information based on the product of the number of data, the specific processing capacity, the occupancy rate, and the processing time. The number of data is the number of data to be processed by the task, which may be expressed in the number of data files or in the amount of data to be processed. The specific processing capability is the type and the processing capability of the computing device mounted on the edge device 20, such as the CPU, NPU, or GPU. The specific processing capability may be previously registered in the task information. The occupancy rate is an occupancy rate of the computing device or the memory when the task is executed. The processing time is an elapsed time from the start time to the end time of the task.

For example, the reward generation unit 150 may generate the reward information based on the product of the number of times the computing is performed and the number of data. The number of times the computing is performed indicates the number of times the computing is performed to execute the task. The number of times the computing is performed may be counted by a monitor program installed in the edge device 20. The number of data is the number of data to be processed by the task, which may be expressed in the number of data files.

For example, the reward generation unit 150 may generate the reward information based on a value obtained by multiplying the sum of the memory size and the program size by the number of data. The number of data is the number of data to be processed by the task, which may be expressed in the number of data files. The memory size is the size of the memory required for the execution of the task. The program size is the size of the program that executes the task.

For example, the reward generation unit 150 may generate the reward information based on the product of the number of times the task is executed and the number of parameters. The number of times the task is executed indicates the number of times the task is executed using the machine learning model. The number of parameters is the number of parameters of the machine learning model that executes the task.

For example, the reward generation unit 150 generates the reward information based on the number of times the task is executed. In this case, the unit price may be fixed to the unit price that is obtained when executing the task once. In other words, the reward generation unit 150 sets the product of the number of times the task is executed and the unit price, as the reward amount.

The evaluation acquisition unit 160 acquires the evaluation information. The evaluation acquisition unit 160 acquires information on the execution speed of the task and the evaluation value input to the resource receiving device.

The evaluation acquisition unit 160 may receive the execution speed of the task from the resource receiving device. The execution speed of the task may be, for example, a time period from the time when the resource receiving device transmits the task execution request, to the time when the resource receiving device receives the task execution result. The execution speed of the task may be normalized based on the amount of computation for the task. The evaluation acquisition unit 160 may calculate the execution speed of the task based on the resource use information received from the resource receiving device.

The evaluation acquisition unit 160 may receive the evaluation value from the resource receiving device. The evaluation value may be input, for example, to an evaluation input screen displayed on the display device 506 of the resource receiving device. For example, the evaluation input screen is displayed on the display device 506 after the execution result of the task is received. The evaluation input screen may receive an input of the evaluation value indicating the satisfaction degree in ranks, for example, in five ranks.

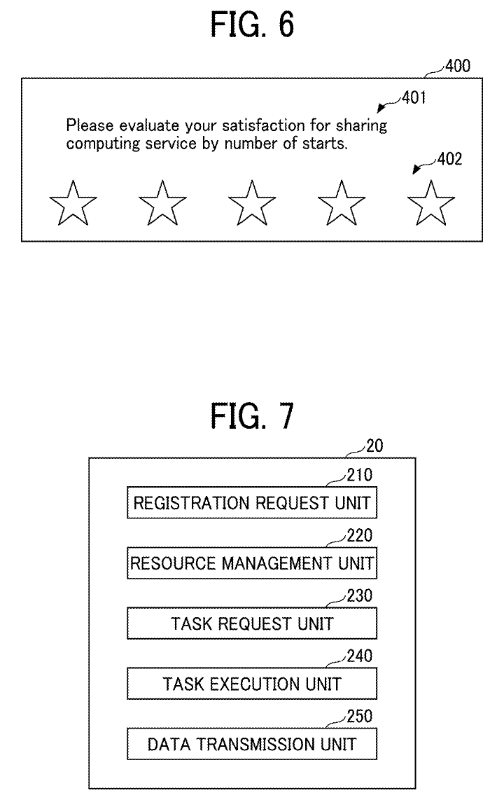

FIG. 6 is a diagram illustrating an example of an evaluation input screen 400. As illustrated in FIG. 6, the evaluation input screen 400 includes a description display area 401 and an evaluation selection area 402. The description display area 401 displays the description of an evaluation method. The evaluation selection area 402 receives the selection of an evaluation value. The evaluation selection area 402 illustrated in FIG. 6 displays five stars, and receives the evaluation value represented by the number of selected stars.

The functional configuration of the server device 10 illustrated in FIG. 3 is an example, and the functional configuration may vary depending on the use or purpose of the server device 10. In other words, the processing units of the server device 10 that are divided as the storage unit 100, the registration unit 110, the request reception unit 120, the selection unit 130, the setting unit 140, the reward generation unit 150, and the evaluation acquisition unit 160, as illustrated in FIG. 3, are one example.

FIG. 7 is a block diagram illustrating an example of a functional configuration of the edge device 20. As illustrated in FIG. 7, the edge device 20 includes a registration request unit 210, a resource management unit 220, a task request unit 230, a task execution unit 240, and a data transmission unit 250. The edge device 20 executes one or more programs that are pre-installed to function as the registration request unit 210, the resource management unit 220, the task request unit 230, the task execution unit 240, and the data transmission unit 250.

For example, the registration request unit 210, the resource management unit 220, the task request unit 230, the task execution unit 240, and the data transmission unit 250 are implemented by processing that is executed by the CPU 501 according to the program that is loaded from the HDD 504 into the RAM 503 illustrated in FIG. 2.

To implement the processing units illustrated in FIG. 7, two or more programs may be installed on the edge device 20. For example, the program installed in the edge device 20 may include a first program that causes the edge device 20 to function as the resource receiving device and a second program that causes the edge device 20 to function as the resource providing device. For example, the first program causes the edge device 20 to implement the registration request unit 210, the resource management unit 220, the task request unit 230, and the data transmission unit 250. The second program causes the edge device 20 to implement the registration request unit 210, the resource management unit 220, the task execution unit 240, and the data transmission unit 250.

The registration request unit 210 transmits an account registration request to the server device 10. The registration request unit 210 receives inputs of the user information, the connection destination information, the task information, and the payment information, from the user. The registration request unit 210 transmits a registration request including the user information, the connection destination information, the task information, and the payment information, which are input, to the server device 10.

The registration request unit 210 generates the encryption information in response to the registration completion notification from the server device 10. In one example, the registration request unit 210 creates the secret key and the public key by adding a random number to the identification information of the account. The registration completion notification includes the identification information of the account. The registration request unit 210 generates the encryption information based on the identification information of the account. The registration request unit 210 transmits a registration request including the generated encryption information to the server device 10.

The resource management unit 220 manages the computing resources of the edge device 20. Specifically, the resource management unit 220 manages the availability of the computing resources of the edge device 20. The resource management unit 220 generates the resource availability information in response to a request from the server device 10. The resource management unit 220 manages the usage of the computing resources when the task is executed. The resource management unit 220 generates the resource use information after the execution of the task is completed.

The task request unit 230 transmits a task execution request to the server device 10. In one example, the task request unit 230 transmits the task execution request including the data to be processed, to the resource providing device set by the server device 10. In another example, the task request unit 230 transmits the task execution request including the data to be processed to the server device 10. The task request unit 230 may encrypt the data to be processed and include the encrypted data in the task execution request.

The task execution unit 240 executes the task in response to the task execution request. The task execution unit 240 executes the task indicated in the task execution request, with respect to the data included in the task execution request. When the execution of the task is completed, the task execution unit 240 transmits the execution result of the task to the resource receiving device. The task execution unit 240 may encrypt the execution result of the task and transmit the encrypted execution result to the resource receiving device.

The data transmission unit 250 transmits the resource availability information to the server device 10. The data transmission unit 250 transmits the resource availability information, which is generated by the resource management unit 220, to the server device 10 in response to the request from the server device 10.

The data transmission unit 250 transmits the resource use information to the server device 10 or another edge device 20. For example, the data transmission unit 250 of the resource receiving device transmits the resource use information to the server device 10 or the resource providing device. The data transmission unit 250 of the resource providing device transmits the resource use information to the server device 10 or the resource receiving device.

The functional configuration of the edge device 20 illustrated in FIG. 7 is an example, and the functional configuration may vary depending on the use or purpose of the edge device 20. The processing units of the edge device 20 illustrated in FIG. 7, which are divided as the registration request unit 210, the resource management unit 220, the task request unit 230, the task execution unit 240, and the data transmission unit 250 illustrated in FIG. 7, are one example.

### Processes

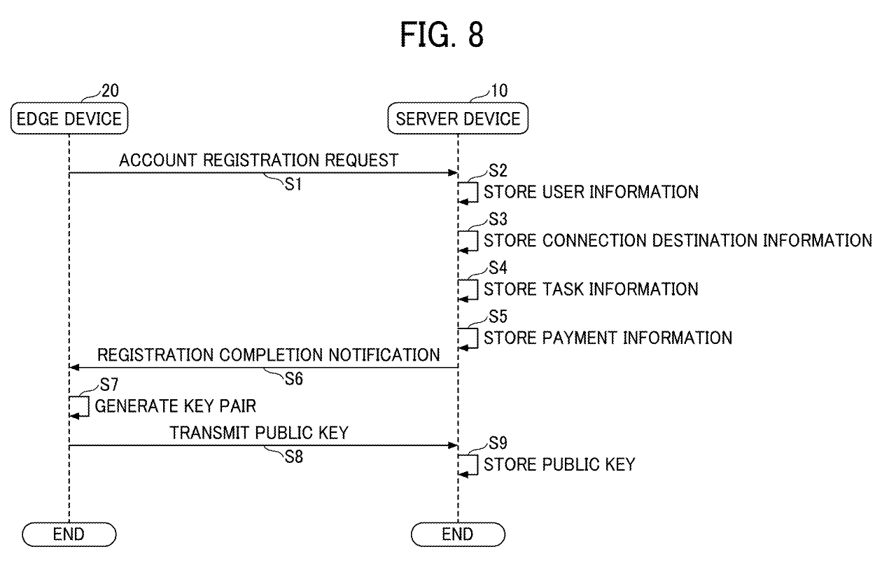

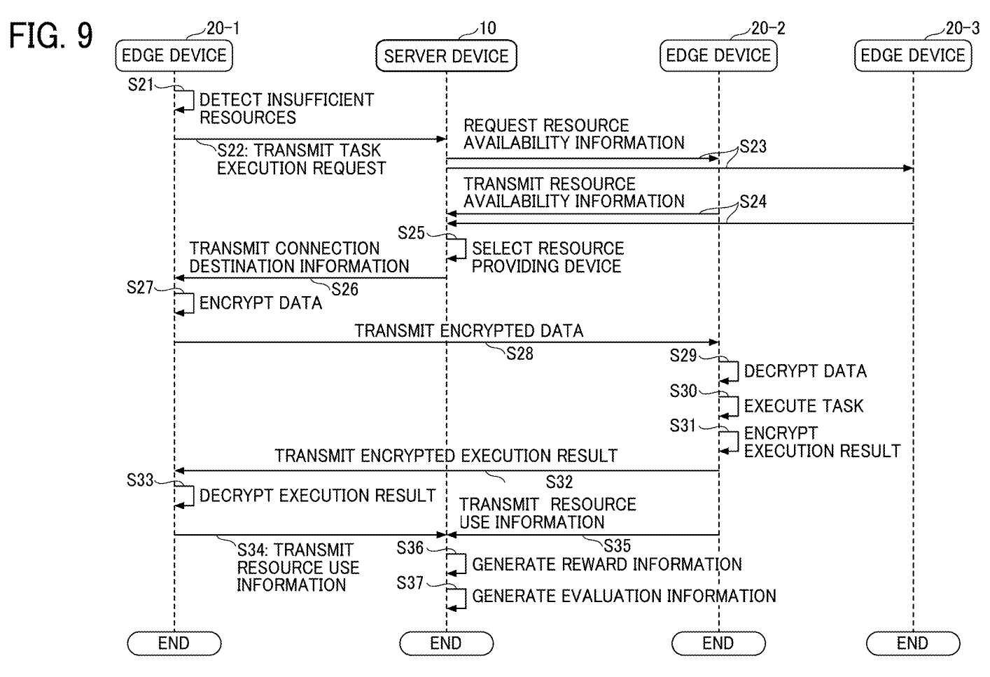

A task management operation including the management of one or more tasks, performed by the task management system 1000, will be described below with reference to FIGS. 8 and 9. The task management operation includes a registration process (see FIG. 8) and an execution process (see FIG. 9).

FIG. 8 is a sequence diagram illustrating an example of the registration process. The registration process is a process of registering the edge device 20 that uses the shared computing service in the server device 10.

The user of the edge device 20 inputs the user information, the connection destination information, the task information, and the payment information, to the edge device 20. In step S1, the registration request unit 210 of the edge device 20 receives the input of the user information, the connection destination information, the task information, and the payment information from the user. The edge device 20 transmits an account registration request to the server device 10. The account registration request includes the user information, the connection destination information, the task information, and the payment information, each of which is input by the user.

In step S2, the server device 10 receives the account registration request from the edge device 20. The registration unit 110 of the server device 10 issues identification information of an account to be given to the edge device 20. The registration unit 110 of the server device 10 acquires the user information from the account registration request received from the edge device 20. The registration unit 110 stores the user information in the storage unit 100.

In step S3, the registration unit 110 of the server device 10 acquires the connection destination information from the account registration request received in step S2. The registration unit 110 stores the acquired connection destination information in the storage unit 100.

In step S4, the registration unit 110 of the server device 10 acquires the task information from the account registration request received in step S2. The registration unit 110 stores the acquired task information in the storage unit 100.

In step S5, the registration unit 110 of the server device 10 acquires the payment information from the account registration request received in step S2. The registration unit 110 stores the acquired payment information in the storage unit 100.

In step S6, the registration unit 110 of the server device 10 transmits the registration completion notification of the account to the edge device 20. The registration completion notification of the account includes the identification information of the account issued in step S2.

In step S7, the edge device 20 receives the registration completion notification of the account from the server device 10. The registration request unit 210 of the edge device 20 acquires the identification information of the account from the registration completion notification. The registration request unit 210 generates the encryption information based on the identification information of the account. In the present embodiment, the registration request unit 210 generates a pair of a public key and a secret key in the public key encryption scheme.

In step S8, the registration request unit 210 of the edge device 20 transmits a request for registering the encryption information to the server device 10. The request for registering the encryption information includes the public key generated in step S7.

In step S9, the server device 10 receives the request for registering the encryption information, which includes the public key, from the edge device 20. The registration unit 110 of the server device 10 acquires the public key from the request for registering, received from the edge device 20. The registration unit 110 stores the public key in the storage unit 100 as the encryption information.

FIG. 9 is a sequence diagram illustrating an example of the execution process. The execution process is a process of executing the task, performed by the resource providing device, in response to a request from the resource receiving device.

In FIG. 9, the edge device 20-1 is the resource receiving device that requests the execution of the task. The edge device 20-2 and the edge device 20-3 are each the edge device capable of executing the task. The edge device 20-2 is the resource providing device that executes the task.

In step S21, the edge device 20-1 starts executing the task. The resource management unit 220 of the edge device 20-1 determines whether or not the computing resources required to execute the task are available based on the availability of the computing resources. The description continues based on the assumption that the computing resources required to execute the task are insufficient.

In step S22, the resource management unit 220 of the edge device 20-1 notifies the task request unit 230 that the computing resources required to execute the task are insufficient. The task request unit 230 transmits a task execution request to the server device 10. The task execution request includes information indicating the task to be executed.

In step S23, the server device 10 receives the task execution request from the edge device 20-1. The selection unit 130 of the server device 10 requests the edge device 20 capable of executing the task to transmit the resource availability information. In this example, the selection unit 130 requests the edge device 20-2 and the edge device 20-3 to transmit the resource availability information.

In step S24, the edge device 20-2 and the edge device 20-3 receive the request for resource availability information from the server device 10. At each of the edge device 20-2 and the edge device 20-3, the resource management unit 220 generates the resource availability information based on the availability of the computing resources. At each of the edge device 20-2 and the edge device 20-3, the data transmission unit 250 transmits the resource availability information generated by the resource management unit 220 to the server device 10.

In step S25, the server device 10 receives the resource availability information from the edge device 20-2 and the edge device 20-3, respectively. The selection unit 130 of the server device 10 selects a resource providing device based on the resource availability information. Alternatively, the selection unit 130 may read the evaluation information of the edge device 20-2 and the edge device 20-3 from the storage unit 100, and select the resource providing device based on the resource availability information and the evaluation information. In this example, the description continues based on the assumption that the edge device 20-2 is selected as the resource providing device.

Although the case where the resource availability information of the edge device 20-3 indicates that the resources, such as the memory capacity, are insufficient, has been described above, the edge device 20-3 may be selected as the resource providing device in addition to the edge device 20-2 in a case where the resource availability information of the edge device 20-3 indicates that the available resources are sufficient and the evaluation of the edge device 20-3 is high.

In step S26, the selection unit 130 of the server device 10 notifies the setting unit 140 of the selection of the edge device 20-2 in step S25. The setting unit 140 reads the connection destination information and the public key of the edge device 20-2 from the storage unit 100. The setting unit 140 transmits the connection destination information and the public key of the edge device 20-2 to the edge device 20-1.

In step S27, the edge device 20-1 receives the connection destination information and the public key of the edge device 20-2 from the server device 10. The task request unit 230 of the edge device 20-1 encrypts the data to be processed by the task using the public key of the edge device 20-2.

In step S28, the task request unit 230 of the edge device 20-1 transmits a task execution request to the edge device 20-2. The task execution request includes the data encrypted in step S27.

In step S29, the edge device 20-2 receives the task execution request from the edge device 20-1. The task execution unit 240 of the edge device 20-2 acquires the encrypted data from the task execution request. The task execution unit 240 decrypts the encrypted data using the private key generated in step S7 of the registration process illustrated in FIG. 8.

In step S30, the task execution unit 240 of the edge device 20-2 executes the task indicated in the task execution request received in step S29, to process the data decrypted in step S29. The task execution unit 240 may execute the task by secret computation. In this case, the encrypted data does not need to be decrypted, such that step S29 may not be performed.

In step S31, the task execution unit 240 of the edge device 20-2 encrypts the execution result of the task using the public key of the edge device 20-1. The public key of the edge device 20-1 may be acquired from the server device 10 or may be received from the edge device 20-1. For example, the public key of the edge device 20-1 may be included in the task execution request. When the task is executed by secret computation in step S30, step S31 may not be executed as the execution result of the task is already encrypted.

In step S32, the edge device 20-2 transmits the execution result of the task to the edge device 20-2. The execution result of the task includes the result of executing the task encrypted in step S30.

In step S33, the edge device 20-1 receives the execution result of the task from the edge device 20-2. The task request unit 230 of the edge device 20-1 decrypts the execution result of the task using the private key generated in step S7 of the registration process illustrated in FIG. 8.

In step S34, the data transmission unit 250 of the edge device 20-1 generates resource use information based on the task execution request transmitted to the edge device 20-2 in step S28. The data transmission unit 250 transmits the generated resource use information to the server device 10. The data transmission unit 250 may transmit the generated resource use information to the edge device 20-2.

The data transmission unit 250 of the edge device 20-1 may generate only information that can be generated from among the resource use information. Further, the data transmission unit 250 may generate only information used for generating the reward information from among the resource use information. When the edge device 20-1 is not capable of generating the information used for generating the reward information, step S34 may not be performed.

In step S35, the resource management unit 220 of the edge device 20-2 generates the resource use information based on the usage of the computing resources when the task is executed, for example, as described above referring to FIG. 3. The data transmission unit 250 transmits the generated resource use information to the server device 10. The data transmission unit 250 may transmit the generated resource use information to the edge device 20-1.

The data transmission unit 250 of the edge device 20-2 may generate only information that can be generated among the resource use information. Further, the data transmission unit 250 may generate only information used for generating the reward information from among the resource use information. When the edge device 20-2 is not capable of generating the information used for generating the reward information, step S35 may not be performed.

In step S36, the server device 10 receives the resource use information from the edge device 20-1 or the edge device 20-2, or each from the edge device 20-1 and the edge device 20-2. The reward generation unit 150 of the server device 10 generates the reward information related to the execution of the task based on the resource use information. The reward generation unit 150 stores the generated reward information in the storage unit 100.

In step S37, the evaluation acquisition unit 160 of the server device 10 acquires the evaluation information. At this time, the evaluation acquisition unit 160 may cause the display device 506 of the edge device 20-1 to display the evaluation input screen, and acquire an evaluation value input to the evaluation input screen as the evaluation information. The evaluation acquisition unit 160 may generate the evaluation information indicating the execution speed of the task based on the resource use information received in step S36. The evaluation acquisition unit 160 stores the generated evaluation information in the storage unit 100.

Although FIG. 9 illustrates an example in which only the edge device 20-2 is requested to execute the task, multiple edge devices 20 may be selected as the resource providing devices. The task is then divided into multiple tasks based on the resource availability information of the resource providing devices, and requests for executing the tasks are transmitted to the corresponding resource providing devices.

As described above, the server device 10 performs a task management method, which includes receiving a request for executing a task from the edge device 20-1, setting the edge device 20-2 to execute the task, and generating reward information related to the execution of the task based on information indicating the computing resources for the task.

Accordingly, the reward information related to the execution of the task is generated based on the information indicating the computing resources for the task. In other words, the reward information related to the execution of the task can be appropriately generated.

In the present disclosure, the server device 10 is an example of a first information processing device. The edge device 20-1 is an example of a second information processing device that receives the computing resources, which may be referred to as the resource receiving device. The edge device 20-2 is an example of a third information processing device that executes a task, which may be referred to as the resource providing device. The edge device 20-2 and the edge device 20-3 (edge devices 20) are each an example of a fourth information processing device capable of executing a task, which may be referred to as the registered resource providing device.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

In one aspect, an information processing apparatus communicably connected with a second information processing device via a network, includes: a request reception unit that receives an request for executing a task from the second information processing device; a setting unit that sets a third information processing device to execute the task; and a reward generation unit that generates reward information related to execution of the task based on information indicating computing resources related to the task.

1. A non-transitory recording medium storing a plurality of instructions which, when executed by one or more processors on a first information processing device, causes the one or more processors to perform an information processing method comprising:
receiving a request for executing a task from a second information processing device;
setting a third information processing device to execute the task; and
generating reward information related to execution of the task based on information indicating computing resources for the task.

2. The non-transitory recording medium according to claim 1, wherein the information indicating the computing resources includes at least one of
information related to processing content of the task, or
information related to data to be processed by the task.

3. The non-transitory recording medium according to claim 2, wherein the information related to the processing content of the task includes at least one of:
a number of parameters of a machine learning model that executes the task;
processing capability of a computing device in the third information processing device;
a size of a program that executes the task;
a size of a memory required for executing the task; or
a number of times the task is executed.

4. The non-transitory recording medium according to claim 2, wherein the information related to the data to be processed includes at least one of:
a number of the data;
a size of the data;
a number of tokens of the data;
an occupancy rate of a computing device or a memory for the task being executed;
a processing time of the task being executed; or
a number of times the computing is performed to execute the task.

5. The non-transitory recording medium according to claim 1, wherein the method further comprises:
registering one or more resource providing devices capable of providing the computing resources; and
selecting the third information processing device to execute the task indicated by the request, from the registered resource providing devices.

6. The non-transitory recording medium according to claim 5, wherein the selecting includes
selecting the third information processing device based on a requirement for allowing the execution of the task, the requirement having been set at the second information processing device.

7. The non-transitory recording medium according to claim 5, wherein the selecting includes
selecting the third information processing device based on a requirement for allowing the execution of the task, the requirement having been set at the third information processing device.

8. The non-transitory recording medium according to claim 5, wherein the method further comprises:
acquiring, from each of the registered resource providing devices, an evaluation result indicating an evaluation of the task executed by the registered resource providing device,
wherein the selecting includes selecting the third information processing device based on the evaluation result.

9. The non-transitory recording medium according to claim 8, wherein the evaluation result includes information related to an execution speed of the task.

10. The non-transitory recording medium according to claim 8, wherein the evaluation result includes an evaluation value input to the second information processing device.

11. A non-transitory recording medium storing a plurality of instructions which, when executed by one or more processors on an information processing apparatus, the method comprising:
transmitting a request that requests another information processing to execute a task to a task management apparatus; and
transmitting information indicating computing resources for the task to one of the task management apparatus and said another information processing apparatus.

12. A non-transitory recording medium storing a plurality of instructions which, when executed by one or more processors on an information processing apparatus, the method comprising:
receiving a request for executing a task from another information processing apparatus via a task management apparatus;
executing the task in response to the request for executing a task; and
transmitting information indicating computing resources for the task to one of the task management apparatus or said another information processing apparatus.
